(19) United States
(12) Patent Application Publication
(10) Pub. No.: US 2025/0371991 A1
(43) Pub. Date: Dec. 4, 2025

(54) QUESTION PROCESSING DEVICE, QUESTION PROCESSING METHOD, AND PROGRAM

(71) Applicants: Kwansei Gakuin Educational Foundation, Hyogo (JP); MICWARE CO., LTD., Hyogo (JP)

(72) Inventors: Kazutoshi SUMIYA, Hyogo (JP); Saki INOUE, Hyogo (JP); Yukiko KAWAI, Kyoto (JP); Yuanyuan WANG, Yamaguchi (JP)

(21) Appl. No.: 19/197,923

(22) Filed: May 2, 2025

(30) Foreign Application Priority Data
May 31, 2024 (JP) 2024-089314

(51) Int. Cl. G09B 5/14

(52) U.S. Cl. CPC G09B 5/14

(57) ABSTRACT

A question processing device includes a question receiver that receives, during a lecture provided by an instructor to two or more students, a question about the lecture from each of two or more student terminals, a question processor that performs information processing on two or more questions received by the question receiver and obtains a processing result, and a result transmitter that transmits the processing result obtained by the question processor to an instructor terminal or the two or more student terminals. The question processing device can perform effective information processing on questions transmitted from students during a lecture and provide appropriate benefit to the students or the instructor.

### BACKGROUND OF INVENTION

### Field of the Invention

The present invention relates to a question processing device that receives questions from two or more students, processes the questions, and transmits the processing results.

### Background Art

A known technique provides practice questions to students using automatic question generation (AQG) and evaluates discrimination between questions generated through AQG and human-authored (HA) questions (refer to Non-Patent Literature 1).

A known technique for learning support methods promotes communication among students during a class (refer to Patent Literature 1).

Additionally, a known technique for survey result analysis systems can identify a new population that provides reaction data useful for marketing (refer to Patent Literature 2).

### CITATION LIST

### Patent Literature

Patent Literature 1: Japanese Unexamined Patent Application Publication No. 2022-98220
Patent Literature 2: Japanese Patent No. 6813917

### Non-Patent Literature

Non-Patent Literature 1: Benny G. Johnson; Jeffrey S. Dittel; Rachel Van Campenhout; Bill Jerome, Discrimination of automatically generated questions used as formative practice. Proceedings of the Ninth ACM Conference on Learning @Scale, L@S '22, 325-329, New York, NY, USA, 2022. Association for Computing Machinery.

### SUMMARY OF INVENTION

However, the known techniques may not allow effective information processing on questions transmitted from students during a lecture, failing to provide appropriate benefit to the students or the instructor. The benefit may be referred to as, for example, convenience or usefulness.

A question processing device according to a first aspect of the present invention includes a question receiver that receives, during a lecture provided by an instructor to two or more students, a question about the lecture from each of two or more student terminals, a question processor that performs information processing on two or more questions received by the question receiver and obtains a processing result, and a result transmitter that transmits the processing result obtained by the question processor to an instructor terminal or the two or more student terminals.

The question processing device in this aspect can perform effective information processing on questions transmitted from students during a lecture and provide appropriate benefit to the students or the instructor.

A question processing device according to a second aspect is the question processing device according to the first aspect in which the question receiver receives a question associated with a student identifier. The question processing device according to the second aspect further includes a reaction receiver that receives reaction information indicating an evaluation on each question of the two or more questions. The reaction receiver receives the reaction information from a student terminal held by at least one student other than a student who has transmitted the corresponding question. In the second aspect, the question processor includes a level obtainer that obtains, using the reaction information received by the reaction receiver, a level of the question corresponding to the reaction information, and a level storage that stores the level obtained by the level obtainer in a manner associated with the student identifier.

The question processing device in this aspect can determine the level of a student who has transmitted a question based on evaluation performed on the question by other students.

A question processing device according to a third aspect is the question processing device according to the second aspect in which the question processor further includes a question recommender that obtains, from a question manager managing two or more levels in a manner each associated with at least one question, a question associated with a level of a student identified by the student identifier and transmits the obtained question to a student terminal identified by the student identifier.

The question processing device in this aspect can suggest, to a student, a question corresponding to the level of the student.

A question processing device according to a fourth aspect is the question processing device according to the first aspect in which the question processor includes a combiner that combines two or more questions satisfying a similarity condition into a single question among two or more questions received by the question receiver during a lecture, and a combined-question transmitter that transmits at least one question remaining after the combiner combining the two or more questions.

The question processing device in this aspect can narrow down questions transmitted from students during a lecture by combining questions satisfying the similarity condition.

A question processing device according to a fifth aspect is the question processing device according to the fourth aspect in which the combiner combines, at a predetermined time in the lecture, the two or more questions satisfying the similarity condition into the single question among the two or more questions received by the question receiver during the lecture.

The question processing device in this aspect can combine questions at an appropriate time during a lecture, thus being useful for a lecture in which questions are answered near the end of the lecture.

A question processing device according to a sixth aspect is the question processing device according to the fourth or fifth aspect in which the question processor further includes a sorter that sorts, in descending order, questions resulting from the combining performed by the combiner using a number of original questions as a key. In the sixth aspect, the combined-question transmitter transmits two or more questions resulting from the combining and sorted by the sorter.

The question processing device in this aspect allows, for example, the instructor to easily identify a question about topics that interest many students.

A question processing device according to a seventh aspect is the question processing device according to the first aspect in which the lecture is provided by the instructor with material having two or more pages. In the seventh aspect, the question processor includes a correspondence obtainer that detects correspondence between the question received by the question receiver and a page of the material and obtains a page identifier identifying the page, and a question storage that stores the question in a manner associated with the page identifier or the page.

The question processing device in this aspect can appropriately associate a question with lecture material.

A question processing device according to an eighth aspect is the question processing device according to the seventh aspect in which the question processor further includes a question identifier receiver that receives a question identifier identifying a question from the instructor terminal, and a page transmitter that transmits a page identifier or a page paired with the question identifier to the instructor terminal.

The question processing device in this aspect can assist in answering a question and understanding an answer.

The question processing device according to the aspects of the present invention can perform effective information processing on questions transmitted from students during a lecture and provide appropriate benefit to the students or the instructor.

### BRIEF DESCRIPTION OF THE DRAWINGS

FIG. 1 is a conceptual diagram of a question processing system A according to a first embodiment.

FIG. 2 is a block diagram of the question processing system A according to the first embodiment.

FIG. 3 is a block diagram of a question processing device 1 according to the first embodiment.

FIG. 4 is a flowchart describing an operation example of the question processing device 1 according to the first embodiment.

FIG. 5 is a flowchart describing the operation example of the question processing device 1 according to the first embodiment.

FIG. 6 is a flowchart describing an example of question combining in the first embodiment.

FIG. 7 is a flowchart describing an example of question sorting in the first embodiment.

FIG. 8 is a flowchart describing an example of student evaluation in the first embodiment.

FIG. 9 is a flowchart describing an example of material analysis in the first embodiment.

FIG. 10 is a flowchart describing an operation example of a student terminal 2 in the first embodiment.

FIG. 11 is a flowchart describing an operation example of an instructor terminal 3 in the first embodiment.

FIG. 12 is a diagram showing an example of a posted question list screen in the first embodiment.

FIG. 13 is a diagram describing reaction information in the first embodiment.

FIG. 14 is a block diagram of a computer system in the first embodiment.

### DETAILED DESCRIPTION

Embodiments of a question processing device will now be described with reference to the drawings. In the embodiments, components denoted with the same reference numeral operate in the same manner and may not be described repeatedly.

### First Embodiment

A question processing device according to the present embodiment described below processes two or more questions and transmits the processing results to an instructor terminal or student terminals.

The question processing device described in the present embodiment accepts at least one other student's evaluation on a question of one student, obtains the level of the question based on the evaluations, determines the level of the student based on the obtained level, and outputs the determined level.

The question processing device described in the present embodiment uses the level of the student to recommend a question corresponding to the level to a student terminal 2.

The question processing device described in the present embodiment combines two or more synonymous or similar questions and transmits at least one question resulting from the combining to the instructor terminal.

The question processing device described in the present embodiment sorts the questions to be transmitted to the instructor terminal using the number of original questions before being combined as a key.

The question processing device described in the present embodiment associates questions with pages and stores the questions during a lecture in which lecture material having two or more pages is used.

The question processing device described in the present embodiment receives a question instruction from the instructor terminal and outputs the page associated with the question when the instructor answers a question.

Information X being associated with information Y herein refers to the information Y being obtainable from the information X or the information X being obtainable from the information Y The association may be achieved in any manner. The information X and the information Y may be linked together or may be in the same buffer. The information X may be included in the information Y The information Y may be included in the information X.

Selecting or determining information Z herein refers to accessing the information Z, such as obtaining the information Z, obtaining a pointer to the information Z, obtaining the ID of the information Z, or flagging the information Z.

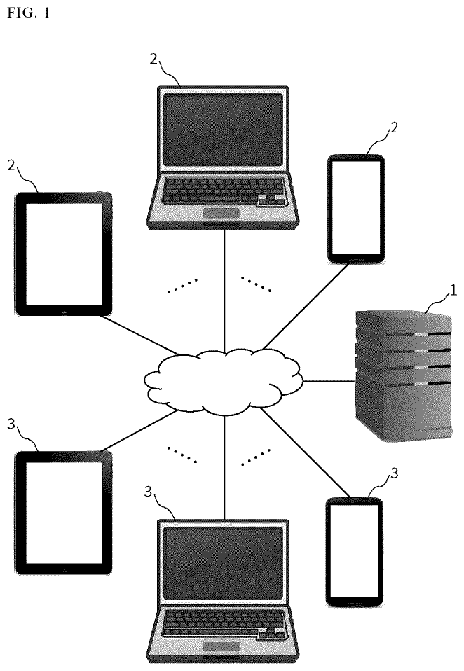

FIG. 1 is a conceptual diagram of a question processing system A according to the present embodiment. The question processing system A includes a question processing device 1, two or more student terminals 2, and an instructor terminal 3.

The question processing device 1 is a server that receives questions from two or more students and processes the questions. The question processing device 1 is, for example, a cloud server or an application service provider (ASP) server of any type.

The student terminals 2 are terminals used by students in a lecture. The lecture is typically a class in a school, such as a college, a high school, a middle school, an elementary school, or a vocational school. The lecture can be interpreted broadly and may include a lecture in an educational institution, such as a tutoring school or a prep school, a seminar, a workshop, or a briefing session. The lecture is, for example, provided by an instructor with material having two or more pages. The students listen to the lecture. The students may include, for example, any students, including working adults.

The instructor terminal 3 is a terminal used by an instructor. The instructor provides a lecture. For example, the instructor explains to students.

The student terminals 2 and the instructor terminal 3 are terminals of any type, such as smartphones, tablets, and personal computers.

The question processing device 1 can communicate with the student terminals 2 and the instructor terminal 3 through a network, such as the Internet.

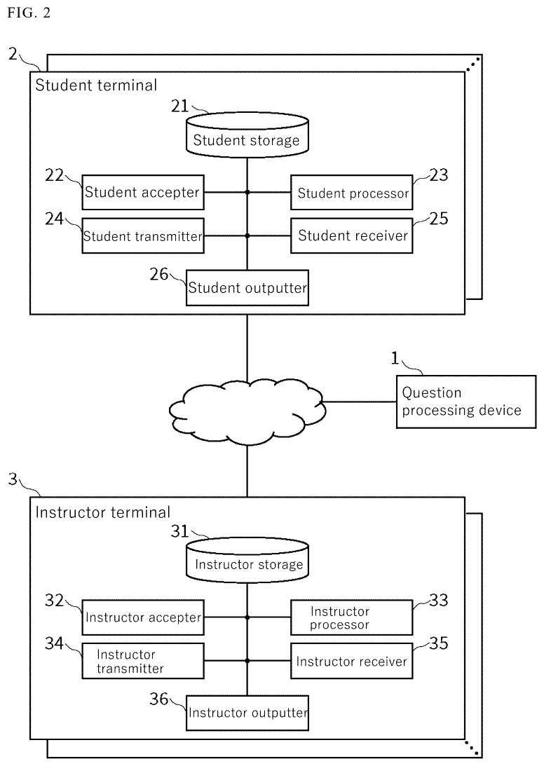

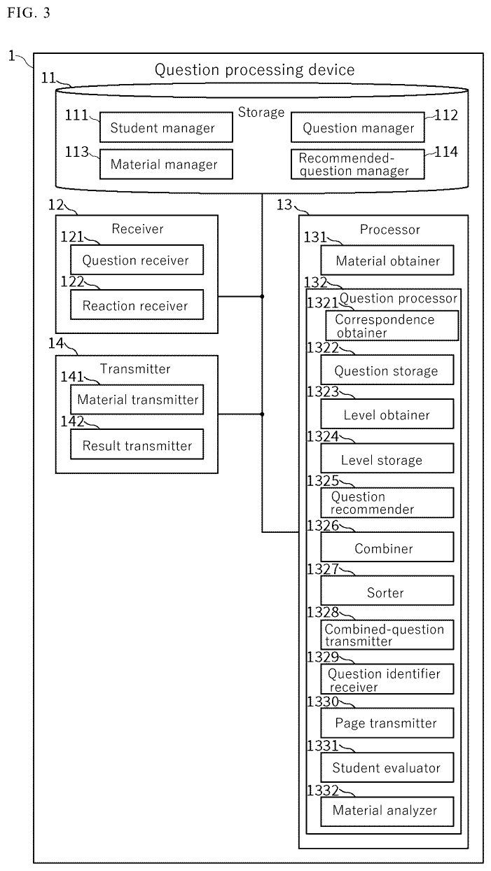

FIG. 2 is a block diagram of the question processing system A according to the present embodiment. FIG. 3 is a block diagram of the question processing device 1.

The question processing device 1 includes a storage 11, a receiver 12, a processor 13, and a transmitter 14. The storage 11 includes a student manager 111, a question manager 112, a material manager 113, and a recommended-question manager 114. The receiver 12 includes a question receiver 121 and a reaction receiver 122. The processor 13 includes a material obtainer 131 and a question processor 132. The question processor 132 includes a correspondence obtainer 1321, a question storage 1322, a level obtainer 1323, a level storage 1324, a question recommender 1325, a combiner 1326, a sorter 1327, a combined-question transmitter 1328, a question identifier receiver 1329, a page transmitter 1330, a student evaluator 1331, and a material analyzer 1332. The transmitter 14 includes a material transmitter 141 and a result transmitter 142.

The student terminal 2 includes a student storage 21, a student accepter 22, a student processor 23, a student transmitter 24, a student receiver 25, and a student outputter 26.

The instructor terminal 3 includes an instructor storage 31, an instructor accepter 32, an instructor processor 33, an instructor transmitter 34, an instructor receiver 35, and an instructor outputter 36.

The storage 11 included in the question processing device 1 stores various types of information. Examples of the various types of information include student information described later, question information described later, material information described later, and recommended questions described later.

The student manager 111 stores two or more items of student information. The student information is information about a student. The student information includes a student identifier and one or more student attribute values. Examples of student attribute values include a level. The level is, for example, the level of a student determined based on one or more questions asked by the student. The level is, for example, the academic level of the student.

The question manager 112 stores two or more items of question information. The question information is information about a question. The question information includes a student identifier, a question, a level, and a material identifier. The student identifier identifies the student who has transmitted the question. The question included in the question information is a question transmitted by the student, a question about the lecture being taken by the student, and typically a character string. The question may refer to the details of the question. The level is the level of the question. The material identifier is information for identifying the material corresponding to the question. The material is used in the lecture. The material identifier is, for example, a page identifier. The material identifier is, for example, a set of a document identifier and a page identifier. The page identifier is a page number or a page ID. The document identifier is information for identifying the lecture material. The document identifier is, for example, the ID of the lecture material or the file name of the lecture material.

The material manager 113 stores one or more items of material information. The material information is information about lecture material. The material information includes, for example, a material identifier, an instructor identifier, and the actual data (typically, a file) of the lecture material.

The recommended-question manager 114 stores one or more recommended questions corresponding to two or more levels. The recommended questions are questions recommended to students. The recommended questions may be simply referred to as questions. The levels are the levels of the students. The levels may also be the ranks of the students.

The receiver 12 receives various types of information and instructions as digital signals. The various types of information and instructions refer to a question, reaction information, a lecture start instruction, and a page turning instruction. The lecture start instruction is an instruction to start the lecture. The lecture start instruction includes, for example, a material identifier and an instructor identifier. The page turning instruction is an instruction to turn a page of the lecture material.

The question receiver 121 receives, during a lecture provided by the instructor to two or more students, a question about the lecture from each of one or more student terminals 2 as a digital signal. The question receiver 121 may receive a question associated with a student identifier.

The reaction receiver 122 receives, as a digital signal, reaction information indicating an evaluation on each of the two or more questions from the student terminal 2 held by at least one student other than the student who has transmitted the question. The reaction receiver 122 may also receive reaction information from the student terminal 2 held by the student who has transmitted the question. The reaction information received by the reaction receiver 122 is, for example, associated with the question identifier. The reaction information received by the reaction receiver 122 may be associated with the student identifier of the student who has transmitted the question. The reaction information received by the reaction receiver 122 is, for example, associated with the student identifier of the student who has transmitted the reaction information.

The reaction information is information indicating an evaluation on a question. The evaluation can be simply based on an impression or a feeling. Examples of the reaction information include Relatable Question (e.g., 1), Answerable Question (e.g., 2), Unexpected Question (e.g., 3), Advanced Question (e.g., 4), and Other Question (e.g., 5). Relatable Question is a question that also interests the reacting student. Unexpected Question is a question having a perspective different from the perspective of the reacting student. Advanced Question is a question difficult to understand at the level of understanding of the reacting student. Other Question is a question not falling under 1 to 4. The reaction information may also be referred to as a reaction. The reaction information is information for identifying a reaction to a question.

The processor 13 performs various types of processing. The various types of processing are, for example, performed by the material obtainer 131 or the question processor 132.

When a question is received, for example, the processor 13 obtains a question identifier of the question, which is a unique question identifier.

The material obtainer 131 obtains material information or the actual data of lecture material from the material manager 113. The material information refers to materials used in a lecture. Upon reception of a lecture start instruction from the instructor terminal 3, for example, the material obtainer 131 obtains the material information or the actual data of the lecture material corresponding to the lecture start instruction.

The question processor 132 performs information processing on the two or more questions received by the question receiver 121 and obtains processing results. The question processor 132 may perform, during a lecture, information processing on two or more questions received during the lecture and obtain processing results. The question processor 132 may perform, after the end of the lecture, information processing on two or more questions received during the lecture and obtain processing results. The information processing includes, for example, in-lecture processing or post-lecture processing. The in-lecture processing is processing that assists in the progress of the lecture. The in-lecture processing includes, for example, question recommendation described later, question combining described later, and question mapping described later. The post-lecture processing is performed after the lecture. The post-lecture processing includes, for example, student evaluation described later and material analysis described later.

The correspondence obtainer 1321 and the question storage 1322 perform question mapping.

The correspondence obtainer 1321 detects the correspondence between a question received by the question receiver 121 and a page of the material and obtains a page identifier that identifies the page.

The correspondence obtainer 1321 obtains, for example, a current page identifier from the storage 11 when the question receiver 121 receives a question.

The correspondence obtainer 1321 obtains, for example, a page identifier of the page most similar to the question received by the question receiver 121. In this case, for example, the pages of the lecture material in the material manager 113 have been converted to page vectors, which are stored in a manner associated with the page identifiers. The correspondence obtainer 1321 also vectorizes, for example, the question received by the question receiver 121 and obtains a page identifier paired with the page vector most similar to the vector of the question.

The question storage 1322 stores the question received by the question receiver 121 in a manner associated with the page identifier or the page. The question storage 1322 may store the question received by the question receiver 121 in a manner associated with the lecture material. The question storage 1322 typically stores questions into the question manager 112. The question storage 1322 typically stores the question received by the question receiver 121 in a manner associated with the page identifier obtained by the correspondence obtainer 1321 or the page identified by the page identifier.

The level obtainer 1323 uses one or more items of reaction information received by the reaction receiver 122 to obtain the level of the question corresponding to at least one item of reaction information.

The reaction information indicates a higher level in response to the level obtainer 1323 obtaining a higher level for the question.

The level obtainer 1323 obtains, for example, the level of a question from Formula 1 below.

$$S ( q ) = - {w}_{1} ( \frac{{R}_{s}}{RA} ) - {w}_{2} ( \frac{{R}_{k}}{RA} ) + {w}_{3} ( \frac{{R}_{u}}{RA} ) + {w}_{4} ( \frac{{R}_{a}}{RA} ) \qquad ( 1 )$$

In Formula 1, S(q) is the level of a question, RA is the total number of reactions, Rₛ is the number of Relatable Question reactions, Rₖ is the number of Answerable Question reactions, Rᵤ is the number of Unexpected Question reactions, and Rₐ is the number of Advanced Question reactions. The weights can be, for example, w₁=w₂=w₃=w₄=0.25, but are not limited to this.

An analysis of the number of reactions to questions reveals the four trends below.
(1) The number of Relatable Question reactions decreases as the question level increases.
(2) The number of Answerable Question reactions decreases as the question level increases.
(3) The number of Unexpected Question reactions increases as the question level increases.
(4) The number of Advanced Question reactions increases as the question level increases.

These trends suggest that the level of a question can be calculated from Formula 1 above based on past question data from students and the proportion of reactions from other students to the question data.

The level obtainer 1323 obtains, for example, a representative value (e.g., the average, the median, or the maximum) of one or more items of reaction information as the level of the question.

The level obtainer 1323 uses, for example, the levels of one or more questions from one student to obtain the level of the student. As the level of the question rises, the level obtainer 1323 obtains a higher level for the student.

The level obtainer 1323 uses, for example, the level of one or more questions from one student to obtain the level of the student with Formula 2.

$$S ( {Un}_{m} ) = {Sn}_{1} ( q ) + {Sn}_{2} ( q ) + ⋯ + {Sn}_{m} ( q ) \qquad ( 2 )$$

In Formula 2, S(Uₙₘ) is the question level of a user n with m questions, and Sₙₘ(q) is the level of the m-th question from the user n. Formula 1 allows the level of a question from a student during the lecture to be calculated, and Formula 2 allows the question level of a student to be obtained. The level obtainer 1323 may use the question levels of two or more students to rank the students. Sₙₘ(q), or the question level of a student, may be a representative value (e.g., the average, the median, or the maximum) of the levels of two or more questions. The question level of a student may also be referred to as the level of the student.

The level storage 1324 stores the levels of one or more questions obtained by the level obtainer 1323 in a manner associated with the student identifier.

The level storage 1324 stores, for example, the level of one student obtained by the level obtainer 1323 in a manner associated with the student identifier of the student.

The question recommender 1325 performs question recommendation. More specifically, the question recommender 1325 obtains a question associated with the level of the student identified by the student identifier from the recommended-question manager 114 and transmits the question to the student terminal 2 identified by the student identifier. The question associated with the level corresponds to the question associated with the student's rank.

The question recommender 1325 recommends, for example, advanced questions (for experts) to top-ranked students and basic questions (for beginners) to lower-ranked students based on the ranks of the obtained question levels of the students. A question with a high question level S(q) can be recommended to a top-ranked student, whereas a question with a low question level S(q) can be recommended to a lower-ranked student. In this manner, a question to be considered next by a student can be searched for in the recommended-question manager 114 (also referred to as a question database) and recommended.

The combiner 1326 performs question combining. More specifically, among the two or more questions received by the question receiver 121 during a lecture, the combiner 1326 combines two or more questions satisfying a similarity condition into a single question. The combiner 1326 can thus group a large number of received questions into one or more fewer questions.

The similarity condition refers to being similar. The similarity condition is, for example, that the similarity between questions, or two character strings, is greater than or equal to a threshold or greater than a threshold.

Among the two or more questions received by the question receiver 121 during a lecture, the combiner 1326 combines two or more questions satisfying the similarity condition into a single question at a predetermined time in the lecture. The predetermined time is, for example, X minutes before the end of the lecture or Y minutes after the start of the lecture. The predetermined time is within the period from the start of the lecture to the end of the lecture.

The sorter 1327 sorts the questions resulting from the combining performed by the combiner 1326 in descending order using the number of original questions as a key. This allows questions from a greater number of students to be ranked higher.

The combined-question transmitter 1328 transmits, as a digital signal, at least one question remaining after the combiner 1326 combining two or more questions. The combined-question transmitter 1328 may transmit the two or more questions resulting from the combining and sorted by the sorter 1327. Although this transmission usually refers to transmission to the instructor terminal 3 of the instructor providing the lecture, the transmission may also include transmission to the student terminals 2 or other devices (not shown). The transmitted question is associated with the question identifier.

The question identifier receiver 1329 receives, from the instructor terminal 3, a question identifier that identifies a question as a digital signal. The question identifier receiver 1329 typically receives a question identifier from the instructor terminal 3 during a lecture. The question identifier is, for example, the identifier of a question answered by the instructor. The question identifier is, for example, the identifier of an output question.

The page transmitter 1330 transmits the page identifier or the page paired with the question identifier received by the question identifier receiver 1329 to the instructor terminal 3 as a digital signal. The instructor terminal 3 displays this page.

The student evaluator 1331 performs student evaluation. More specifically, for each of the one or more student identifiers, the student evaluator 1331 obtains an evaluation value for the student (also referred to as the level of the student) based on the levels stored in the level storage 1324 in one or more lectures and stores the evaluation value in a manner associated with the student identifier. The student evaluator 1331 obtains the levels stored in one or more lectures and paired with the student identifier from the question manager 112 and uses the two or more levels to obtain an evaluation value for the student identified by the student identifier. The evaluation value is, for example, a value calculated based on an increasing function having the two or more levels as parameters. The evaluation value is, for example, a value calculated based on an increasing function having the number of questions and the two or more levels as parameters. The evaluation value is, for example, a representative value (e.g., the average or the median) of the two or more levels. The two or more lectures are, for example, a series of two or more lectures of one unit, one subject, or one course.

The material analyzer 1332 performs material analysis. More specifically, for every two or more pages of material, the material analyzer 1332 performs statistical processing on at least one question paired with the corresponding page, obtains statistical processing results, and outputs the statistical processing results. The statistical processing results are, for example, the number of questions, the number of questions for each question level, or the number of questions lower than a predetermined level.

The transmitter 14 transmits various types of information as digital signals. Examples of the various types of information include lecture materials and processing results obtained by the question processor 132.

The material transmitter 141 transmits material in the material manager 113. The material transmitter 141 transmits, for example, material in the material manager 113 to the instructor terminal 3 as a digital signal.

The result transmitter 142 transmits the processing results obtained by the question processor 132 to the instructor terminal 3 or the student terminals 2 as a digital signal. The result transmitter 142 transmits, for example, a received question to the instructor terminal 3 or at least one student terminal 2.

The student storage 21 included in the student terminal 2 stores various types of information. Examples of the various types of information include a student identifier.

The student accepter 22 accepts various types of information and instructions. Examples of the various types of information and instructions include a question and reaction information.

The various types of information and instructions may be input with any input tool, such as a touchscreen, a keyboard, a mouse, or a menu screen.

The student processor 23 performs various types of processing. Examples of the various types of processing include conversion of an instruction or information accepted by the student accepter 22 to an instruction or information with a data structure to be transmitted. Examples of the various types of processing include conversion of information received by the student receiver 25 to information with a data structure to be output.

The student transmitter 24 transmits various types of information and instructions as digital signals. Examples of the various types of information and instructions include a question and reaction information.

The student receiver 25 receives various types of information as digital signals. Examples of the various types of information include a question from other students and a recommended question.

The student outputter 26 outputs various types of information. Examples of the various types of information include a question from other students and a recommended question.

The output is a concept that includes display on a display, projection with a projector, printing on a printer, sound output, transmission to an external device, storage into a recording medium, and delivering processing results to another processing device or another program.

The instructor storage 31 included in the instructor terminal 3 stores various types of information. Examples of the various types of information include an instructor identifier and lecture material.

The instructor accepter 32 accepts various types of information and instructions. Examples of the various types of information and instructions include a lecture start instruction, a page turning instruction, a question instruction, an instruction to output student information, and an instruction to output analysis results. The question instruction is an instruction for a question to be answered by the instructor. The question instruction includes a question identifier. The student information includes the level of a student or an evaluation value for the student. The analysis results refer to the results of analysis of a question to lecture material.

The instructor processor 33 performs various types of processing. Examples of the various types of processing include conversion of an instruction or information accepted by the instructor accepter 32 to an instruction or information with a data structure to be transmitted. Examples of the various types of processing include conversion of information received by the instructor receiver 35 to information with a data structure to be output.

The instructor transmitter 34 transmits various types of information and instructions. Examples of the various types of information and instructions include a page turning instruction and a question instruction.

The instructor receiver 35 receives various types of information. Examples of the various types of information include a question from a student, a combined question, student information, and analysis results.

The instructor outputter 36 outputs various types of information. Examples of the various types of information include a question from a student and lecture material.

The storage 11, the student manager 111, the question manager 112, the material manager 113, the student storage 21, and the instructor storage 31 may each be a nonvolatile recording medium, but may also be a volatile recording medium.

The storage 11 and other storages may store information through any process. For example, information may be stored into the storage 11 with a recording medium, information transmitted through a communication line may be stored into the storage 11, or information input with an input device may be stored into the storage 11.

The receiver 12, the question receiver 121, the reaction receiver 122, the transmitter 14, the material transmitter 141, the result transmitter 142, the student transmitter 24, the student receiver 25, the instructor transmitter 34, the instructor receiver 35, the combined-question transmitter 1328, the question identifier receiver 1329, and the page transmitter 1330 are typically implemented by wireless or wired communicators.

The processor 13, the material obtainer 131, the question processor 132, the question storage 1322, the level obtainer 1323, the level storage 1324, the combiner 1326, the sorter 1327, the correspondence obtainer 1321, the question storage 1322, the student processor 23, and the instructor processor 33 may be typically implemented by, for example, processors and memories. The procedures for the processor 13 and other units are typically implemented by software, and the software is stored in a recording medium, such as a read-only memory (ROM). However, the procedures may be implemented by hardware (dedicated circuit). The processors include, but are not limited to, a central processing unit (CPU), a micro processing unit (MPU), and a graphics processing unit (GPU).

The student accepter 22 and the instructor accepter 32 may be implemented by a device driver for an input tool, such as a numeric keypad or a keyboard, or control software on a menu screen.

The student outputter 26 and the instructor outputter 36 may or may not be an output device such as a display or a speaker. The student outputter 26 may be implemented by driver software for an output device or a set of driver software for an output device and the output device.

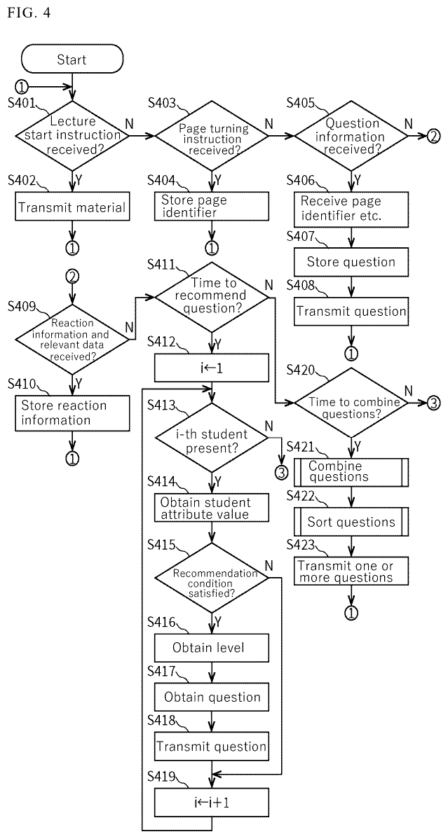

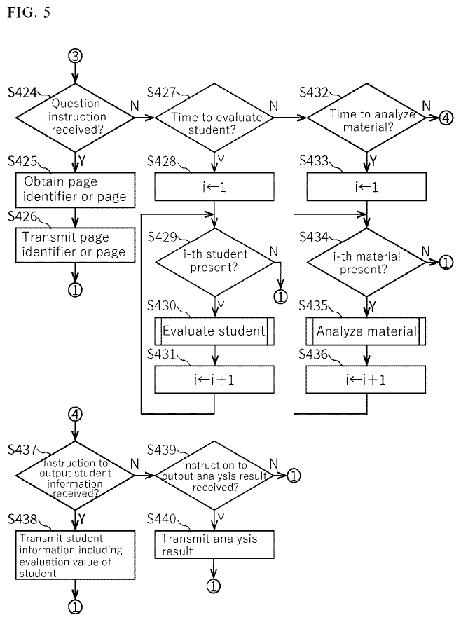

The operation of the question processing device 1 will now be described with reference to the flowcharts in FIGS. 4 and 5.

(S401) The receiver 12 determines whether a lecture start instruction has been received from the instructor terminal 3. With a lecture start instruction received, the processing advances to S402. With no lecture start instruction received, the processing advances to S403.

(S402) The material obtainer 131 obtains material corresponding to the lecture start instruction from the material manager 113. The material transmitter 141 transmits the material to the instructor terminal 3. The processing returns to S401. The material is lecture material used by the instructor (e.g., a PowerPoint file).

(S403) The receiver 12 determines whether a page turning instruction has been received from the instructor terminal 3. With a page turning instruction received, the processing advances to S403. With no page turning instruction received, the processing advances to S405. The page turning instruction is an instruction input into the instructor terminal 3 by the instructor to proceed to the next page of the lecture material.

(S404) The processor 13 temporarily stores, into the storage 11, a current page identifier, which is the page identifier of the next page corresponding to the page turning instruction. The processing returns to S401. This processing allows the question processing device 1 to identify the current page identifier in the lecture.

(S405) The question receiver 121 determines whether question information has been received from a student terminal 2. With question information received, the processing advances to S406. With no question information received, the processing advances to S409. The question information includes a question and a student identifier. The question information may include a lecture identifier.

(S406) The question storage 1322 obtains a question identifier unique to the question. The question storage 1322 obtains a page identifier of the page corresponding to the received question.

(S407) The question storage 1322 stores the received question into the question manager 112 in a manner associated with the question identifier, the student identifier, and the page identifier.

(S408) The transmitter 14 transmits the received question to the instructor terminal 3 and one or more student terminals 2. The processing returns to S401. The question is associated with the question identifier.

(S409) The reaction receiver 122 determines whether reaction information and relevant data have been received from a student terminal 2. With reaction information and relevant data received, the processing advances to S410. With no reaction information and relevant data received, the processing advances to S411. The reaction information and relevant data include, for example, reaction information, a question identifier of the question to be evaluated, and a student identifier of the student who has transmitted the reaction information.

(S410) The question processor 132 stores the reaction information received in S409 into the question manager 112 in a manner associated with the question identifier and the student identifier. The processing returns to S401.

(S411) The question processor 132 determines whether the time has arrived to recommend a question to a student. When the time has arrived to recommend a question, the processing advances to S412. When the time has not arrived, the processing advances to S420. The time to recommend a question is, for example, when a question recommendation condition is satisfied. The question recommendation condition is satisfied, for example, when a predetermined time has passed from the start of the lecture, when a predetermined time before the end of the lecture is reached, or when a predetermined time is reached, as well as when the number of questions received by the question receiver 121 during the lecture is smaller than or equal to a threshold.

(S412) The question recommender 1325 substitutes 1 into a counter i.

(S413) The question recommender 1325 refers to the student manager 111 to determine whether the i-th student attending the lecture is present. With the i-th student present, the processing advances to S414. With the i-th student not present, the processing returns to S401.

(S414) The question recommender 1325 obtains at least one student attribute value of the i-th student attending the lecture from the student manager 111. At least one student attribute value is, for example, the level of the student and information about the student's question history. The information about the student's question history is, for example, the number of questions asked by the student during the lecture or the number of questions asked by the student up to the present.

(S415) The question recommender 1325 determines whether at least one student attribute value satisfies the recommendation condition. With the recommendation condition satisfied, the processing advances to S416. With the recommendation condition dissatisfied, the processing advances to S419.

(S416) The question recommender 1325 obtains the level of the student.

(S417) The question recommender 1325 obtains a question paired with the level from the recommended-question manager 114.

(S418) The question recommender 1325 transmits the question to the student terminal 2 held by at least one student.

(S419) The question recommender 1325 increments the counter i by 1. The processing returns to S413.

(S420) The combiner 1326 determines whether the time has arrived to combine questions. When the time has arrived to combine questions, the processing advances to S421. When the time has not arrived, the processing advances to S424.

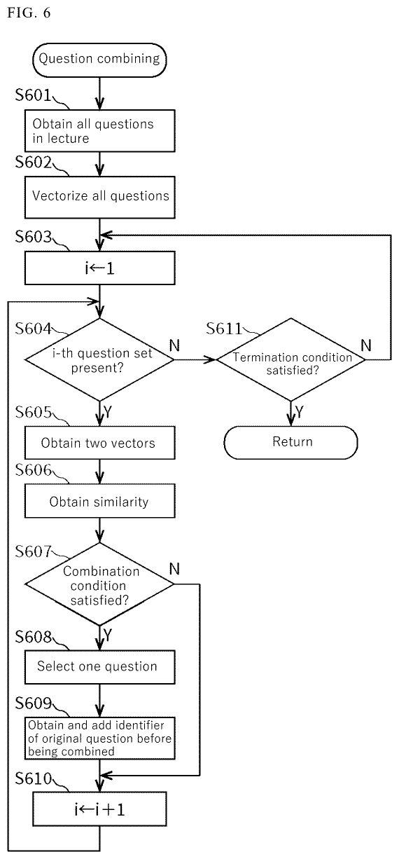

(S421) The combiner 1326 combines questions. An example of the question combining will be described with reference to the flowchart in FIG. 6.

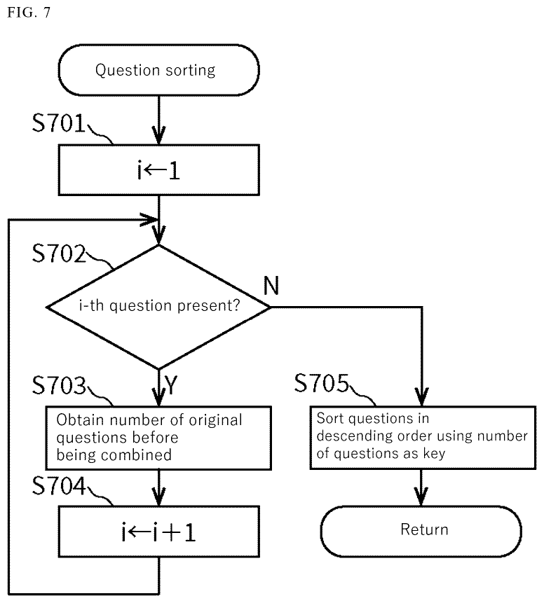

(S422) The sorter 1327 sorts the questions resulting from the combining. An example of the question sorting will be described with reference to the flowchart in FIG. 7.

(S423) The material transmitter 141 transmits one or more questions sorted in S422. The processing returns to S401. The questions are transmitted to, for example, the instructor terminal 3 or the instructor terminal 3 and at least one student terminal 2. The questions sorted in order of the number of identical or similar questions are transmitted. More specifically, a set of questions in which questions that are likely to be prioritized are ranked higher is transmitted.

(S424) The question identifier receiver 1329 determines whether a question instruction has been received from the instructor terminal 3. With a question instruction received, the processing advances to S425. When no question instruction received, the processing advances to S427.

(S425) The page transmitter 1330 obtains a question identifier included in the question instruction. The page transmitter 1330 obtains a page identifier or a page paired with the question identifier.

(S426) The page transmitter 1330 transmits the page identifier or the page to the instructor terminal 3. The processing returns to S401.

(S427) The student evaluator 1331 determines whether the time has arrived to evaluate a student. When the time has arrived to evaluate a student, the processing advances to S428. When the time has not arrived, the processing advances to S432.

(S428) The student evaluator 1331 substitutes 1 into the counter i.

(S429) The student evaluator 1331 determines whether the i-th student to be evaluated is present. With the i-th student present, the processing advances to S430. With the i-th student not present, the processing returns to S401.

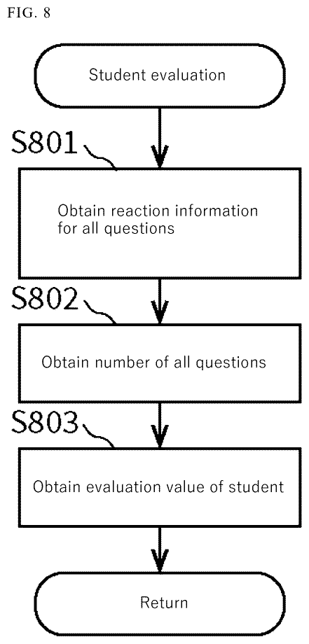

(S430) The student evaluator 1331 obtains the evaluation value of the i-th student. An example of the student evaluation will be described with reference to the flowchart in FIG. 8.

(S431) The student evaluator 1331 increments the counter i by 1. The processing returns to S429.

(S432) The material analyzer 1332 determines whether the time has arrived to analyze material. When the time has arrived to analyze material, the processing advances to S433. When the time has not arrived, the processing advances to S437. The time to analyze material is, for example, any predetermined time after the end of the lecture.

(S433) The material analyzer 1332 substitutes 1 into the counter i.

(S434) The material analyzer 1332 determines whether the i-th material to be analyzed is present. With the i-th material present, the processing advances to S435. With the i-th material not present, the processing returns to S401.

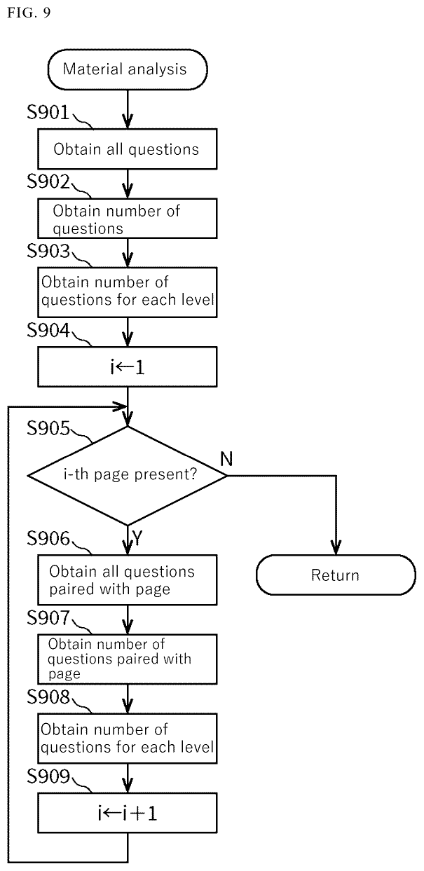

(S435) The material analyzer 1332 analyzes the i-th material. An example of the material analysis will be described with reference to the flowchart in FIG. 9.

(S436) The material analyzer 1332 increments the counter i by 1. The processing returns to S434.

(S437) The receiver 12 determines whether an instruction to output student information has been received from the instructor terminal 3. With an instruction to output student information received, the processing advances to S438. With no such instruction received, the processing advances to S439.

(S438) One or more items of student information corresponding to the instruction to output student information and including the evaluation values of the students are obtained from the student manager 111. The result transmitter 142 transmits the one or more items of student information to the instructor terminal 3. The processing returns to S401.

(S439) The receiver 12 determines whether an instruction to output analysis results has been received from the instructor terminal 3. With an instruction to output analysis results received, the processing advances to S440. With no such instruction received, the processing returns to S401.

(S440) The material analyzer 1332 obtains, from the material manager 113, the material analysis results identified by the instruction to output analysis results. The result transmitter 142 transmits the analysis results to the instructor terminal 3. The processing returns to S401.

In the flowcharts in FIGS. 4 and 5, the process ends when the power is turned off or an interrupt occurs to end the process.

An example of the question combining in S421 will now be described with reference to the flowchart in FIG. 6.

(S601) The combiner 1326 obtains all questions in the lecture from the question manager 112.

(S602) The combiner 1326 obtains, from the character string of each question obtained in S601, a vector corresponding to the question.

(S603) The combiner 1326 substitutes 1 into the counter i.

(S604) The combiner 1326 determines whether the i-th question set is present in all the questions. With the i-th question set present, the processing advances to S605. With the i-th question set not present, the processing advances to S611. The i-th question set contains two questions. Each of the two questions may be a question resulting from combining two questions.

(S605) The combiner 1326 obtains two vectors corresponding to the i-th question set.

(S606) The combiner 1326 calculates the similarity between the two vectors.

(S607) The combiner 1326 determines whether the similarity calculated in S606 satisfies a combination condition. With the combination condition satisfied, the processing advances to S608. With the combination condition dissatisfied, the processing advances to S610.

(S608) The combiner 1326 combines the i-th question set into one question. Typically, one question is selected from the two questions of the i-th question set.

(S609) The combiner 1326 associates the selected one question with the question identifier associated with each question of the i-th question set.

(S610) The combiner 1326 increments the counter i by 1. The processing returns to S604.

(S611) The combiner 1326 determines whether a termination condition is satisfied. With the termination condition satisfied, the processing returns to the higher-level process. With the termination condition dissatisfied, the processing returns to S603. The termination condition is that, for example, the number of remaining questions is smaller than or equal to a threshold or smaller than a threshold, or no similar question remains after the combining.

An example of the question sorting in S422 will now be described with reference to the flowchart in FIG. 7.

(S701) The sorter 1327 substitutes 1 into the counter i.

(S702) The sorter 1327 determines whether the i-th question is present in the questions remaining after the combining. With the i-th question present, the processing advances to S703. With the i-th question not present, the processing advances to S705.

(S703) The sorter 1327 obtains the number of question identifiers associated with the i-th question. The number of question identifiers refers to the number of original questions before being combined into the i-th question.

(S704) The sorter 1327 increments the counter i by 1. The processing returns to S702.

(S705) The sorter 1327 sorts the questions in descending order using the number of questions obtained in S703 as a key. The processing returns to the higher-level process.

An example of the student evaluation in S430 will now be described with reference to the flowchart in FIG. 8.

(S801) The student evaluator 1331 obtains all questions paired with the student identifier of the student to be evaluated. The student evaluator 1331 obtains all items of reaction information paired with the obtained at least one question.

(S802) The student evaluator 1331 obtains the number of all the questions obtained in S801.

(S803) The student evaluator 1331 obtains the evaluation value of the student. The processing returns to the higher-level process. As the level indicated by the reaction information rises, the student evaluator 1331 obtains a higher evaluation value. As the number of questions increases, the student evaluator 1331 obtains a higher evaluation value.

In the flowchart in FIG. 8, the student evaluator 1331 may obtain one or more question levels of the student to be evaluated and use the levels to obtain the evaluation value of the student.

An example of the material analysis in S435 will now be described with reference to the flowchart in FIG. 9.

(S901) The material analyzer 1332 obtains all questions associated with the material to be analyzed.

(S902) The material analyzer 1332 obtains the number of questions obtained in S901 and stores the number of questions in a manner associated with the material.

(S903) The material analyzer 1332 obtains the level of each question obtained in S901. The material analyzer 1332 obtains the number of questions for each level and stores the number of questions for each level in a manner associated with the material.

(S904) The material analyzer 1332 substitutes 1 into the counter i.

(S905) The material analyzer 1332 determines whether the i-th page is present in the material. With the i-th page present, the processing advances to S906. With the i-th page not present, the processing returns to the higher-level process.

(S906) The material analyzer 1332 obtains all questions paired with the page identifier of the i-th page.

(S907) The material analyzer 1332 obtains the number of questions paired with the page identifier of the i-th page and stores the number of questions in a manner associated with the i-th page of the material.

(S908) The material analyzer 1332 obtains the number of questions for each level in a manner associated with the page identifier of the i-th page and stores the number of questions for each level in a manner associated with the i-th page of the material.

(S909) The material analyzer 1332 increments the counter i by 1. The processing returns to S905.

In the flowchart in FIG. 9, the number of all questions corresponding to the material, the number of questions to the material for each question level, the number of all questions for each page, and the number of questions for each question level for each page are obtained.

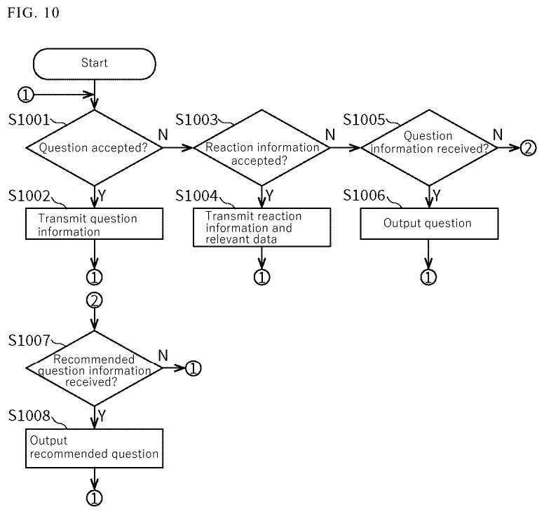

The operation of the student terminal 2 will now be described with reference to the flowchart in FIG. 10.

(S1001) The student accepter 22 determines whether a question has been accepted from the student. With a question accepted, the processing advances to S1002. With no question accepted, the processing advances to S1003.

(S1002) The student processor 23 obtains a student identifier and a lecture identifier from the student storage 21. The student processor 23 forms question information including the accepted question, the student identifier, and the lecture identifier. The student transmitter 24 transmits the question information to the question processing device 1. The processing returns to S1001.

(S1003) The student accepter 22 determines whether reaction information to a question has been accepted from the student. With reaction information accepted, the processing advances to S1004. With no reaction information accepted, the processing advances to S1005.

(S1004) The student processor 23 obtains the student identifier and the lecture identifier from the student storage 21. The student processor 23 obtains the question identifier of the question. The student processor 23 forms reaction information and relevant data including the accepted reaction information and the obtained question identifier, student identifier, and lecture identifier. The student transmitter 24 transmits the reaction information and relevant data to the question processing device 1. The processing returns to S1001.

(S1005) The student receiver 25 determines whether question information has been received from the question processing device 1. With question information received, the processing advances to S1006. With no question information received, the processing advances to S1007. The question information includes, for example, a question, a question identifier, and a lecture identifier.

(S1006) The student processor 23 converts the received question to a data structure to be output. The student outputter 26 outputs the question. The processing returns to S1001.

(S1007) The student receiver 25 determines whether recommended question information has been received from the question processing device 1. With recommended question information received, the processing advances to S1008. With no recommended question information received, the processing returns to S1001. The recommended question information includes, for example, a recommended question and a lecture identifier.

(S1008) The student processor 23 converts the received recommended question to a data structure to be output. The student outputter 26 outputs the recommended question. The processing returns to S1001.

In the flowchart in FIG. 10, the process ends when the power is turned off or an interrupt occurs to end the process.

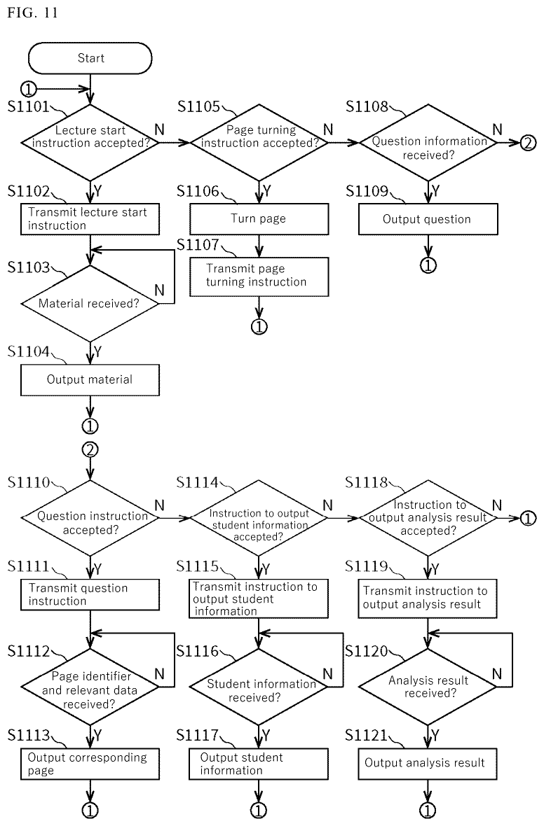

The operation of the instructor terminal 3 will now be described with reference to the flowchart in FIG. 11.

(S1101) The instructor accepter 32 determines whether a lecture start instruction has been accepted. With a lecture start instruction accepted, the processing advances to S1102. With no such instruction accepted, the processing advances to S1105.

(S1102) The instructor processor 33 forms a lecture start instruction to be transmitted. The instructor transmitter 34 transmits the lecture start instruction to the question processing device 1.

(S1103) The instructor receiver 35 determines whether lecture material has been received from the question processing device 1. With the lecture material received, the processing advances to S1104. With no lecture material received, the processing returns to S1103.

(S1104) The instructor outputter 36 outputs the received lecture material. The processing returns to S1101.

(S1105) The instructor accepter 32 determines whether a page turning instruction has been accepted. With a page turning instruction accepted, the processing advances to S1106. With no page turning instruction accepted, the processing advances to S1108.

(S1106) The instructor outputter 36 outputs the next page of the output material.

(S1107) The instructor processor 33 forms a page turning instruction including a lecture identifier. The instructor transmitter 34 transmits the page turning instruction to the question processing device 1. The processing returns to S1101.

(S1108) The instructor receiver 35 determines whether question information has been received from the question processing device 1. With question information received, the processing advances to S1109. With no question information received, the processing advances to S1110. For example, the question information includes a question, a question identifier, and a student identifier.

(S1109) The instructor processor 33 forms a question to be output. The instructor outputter 36 outputs the question. The processing returns to S1101.

(S1110) The instructor accepter 32 determines whether a question instruction has been accepted. With a question instruction accepted, the processing advances to S1111. With no question instruction accepted, the processing advances to S1114.

(S1111) The instructor processor 33 forms a question instruction to be transmitted. The instructor transmitter 34 transmits the question instruction to the question processing device 1. The question instruction includes a question identifier.

(S1112) The instructor receiver 35 determines whether a page identifier or a page paired with the question identifier included in the question instruction has been received. With the page identifier or the page received, the processing advances to S1113. With the page identifier or the page not received, the processing returns to S1112.

(S1113) The instructor processor 33 obtains the page identified by the received page identifier or the received page. The instructor outputter 36 outputs the page. The processing returns to S1101.

(S1114) The instructor accepter 32 determines whether an instruction to output student information has been accepted. With an instruction to output student information accepted, the processing advances to S1115. With no such instruction accepted, the processing advances to S1118.

(S1115) The instructor processor 33 forms an output instruction to be transmitted. The instructor transmitter 34 transmits the instruction to output the student information to the question processing device 1.

(S1116) The instructor receiver 35 determines whether at least one item of student information has been received from the question processing device 1. With at least one item of student information received, the processing advances to S1117. With at least one item not received, the processing returns to S1116.

(S1117) The instructor processor 33 forms at least one item of student information to be output. The instructor outputter 36 outputs the at least one item of student information. The processing returns to S1101.

(S1118) The instructor accepter 32 determines whether an instruction to output analysis results has been accepted. With an instruction to output analysis results accepted, the processing advances to S1119. With no such instruction accepted, the processing returns to S1101.

(S1119) The instructor processor 33 forms an output instruction to be transmitted. The instructor transmitter 34 transmits the instruction to output the analysis results to the question processing device 1.

(S1120) The instructor receiver 35 determines whether analysis results have been received from the question processing device 1. With analysis results received, the processing advances to S1121. With no analysis results received, the processing returns to S1120.

(S1121) The instructor processor 33 forms analysis results to be output. The instructor outputter 36 outputs the analysis results. The processing returns to S1101.

In the flowchart in FIG. 11, the process ends when the power is turned off or an interrupt occurs to end the process.

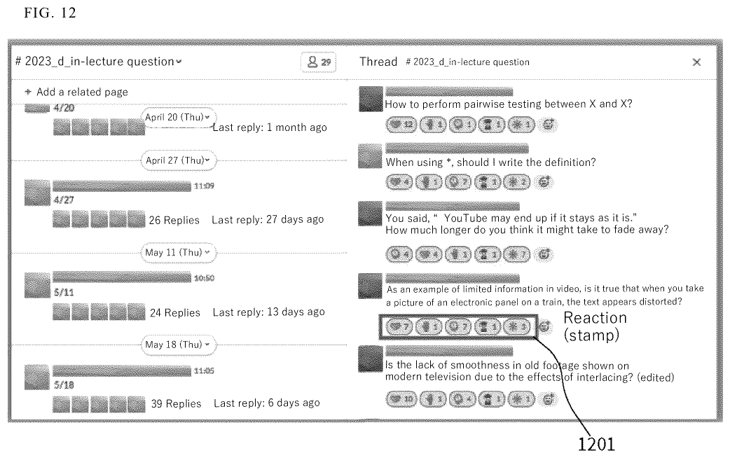

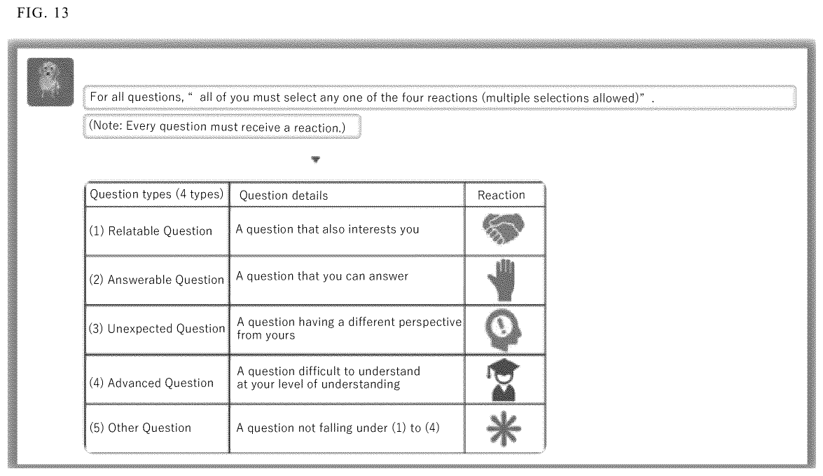

The specific operation of the question processing system A according to the present embodiment will now be described. Students post questions during a lecture. An example of a posted question list screen is shown in FIG. 12. Questions posted by one or more students are transmitted to all the student terminals 2 and the instructor terminal 3, on which a screen similar to that shown in FIG. 12 appears. In FIG. 12, as indicated by 1201, five reaction stamps for inputting reaction information are displayed for each question. Every student terminal 2 displays information shown in FIG. 13 describing the five items of reaction information.

During the lecture, the question from each student receives reaction information input by the other students. As described above, the input reaction information determines the level of each question posted by the student. The evaluation value of the student is also determined based on the level of the question posted by the student. Additionally, a question is recommended to the student based on the evaluation value of the student.

As described above, the question processing device according to the present embodiment can perform effective information processing on questions transmitted from students during a lecture and provide appropriate benefit to the students or the instructor.

The question processing device according to the present embodiment can determine the level of a student who has transmitted a question based on evaluation performed on the question by other students.

The question processing device according to the present embodiment can suggest, to a student, a question corresponding to the level of the student.

The question processing device according to the present embodiment can narrow down questions transmitted from students during a lecture by combining questions satisfying the similarity condition.

The question processing device according to the present embodiment can combine questions at an appropriate time during a lecture, thus being useful for a lecture in which questions are answered near the end of the lecture.

The question processing device according to the present embodiment allows, for example, the instructor to easily identify a question about topics that interest many students.

The question processing device according to the present embodiment can appropriately associate a question with lecture material.

The question processing device according to the present embodiment can assist in answering a question and understanding an answer.

The question processing device according to the present embodiment can evaluate a student based on reactions to a question.

The processes in the present embodiment may be implemented by software. This software may be distributed, for example, through software download. This software may be recorded and distributed on a recording medium, such as a compact disc ROM (CD-ROM). This also applies to other embodiments described herein. The software for implementing the question processing device 1 according to the present embodiment is, for example, the program described below. More specifically, this program is a program for causing a computer to function as a question receiver that receives, during a lecture provided by an instructor to two or more students, a question about the lecture from each of two or more student terminals, a question processor that performs information processing on two or more questions received by the question receiver and obtains a processing result, and a result transmitter that transmits the processing result obtained by the question processor to an instructor terminal or the student terminals.

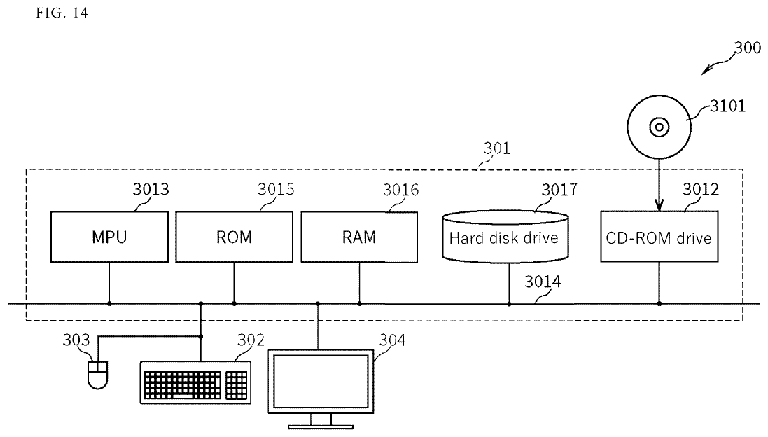

FIG. 14 is a block diagram of a computer system 300 that executes the program described herein to implement the question processing device 1 according to each of the above various embodiments.

In FIG. 14, the computer system 300 includes a computer 301 including a CD-ROM drive, a keyboard 302, a mouse 303, and a monitor 304.

In FIG. 14, the computer 301 includes a CD-ROM drive 3012 as well as an MPU 3013, a bus 3014 connected to the CD-ROM drive 3012 and other units, a ROM 3015 for storing programs such as a boot-up program, a random-access memory (RAM) 3016 connected to the MPU 3013 for temporarily storing an instruction in an application program and providing a temporary storage area, and a hard disk drive 3017 for storing an application program, a system program, and data. Although not shown, the computer 301 may further include a network card that provides connection to a local area network (LAN).

The program for causing the computer system 300 to function as the question processing device 1 according to the above embodiment may be stored in a CD-ROM 3101, which may be inserted in the CD-ROM drive 3012, and transferred to the hard disk drive 3017. In some embodiments, the program may be transmitted to the computer 301 through a network (not shown) and stored into the hard disk drive 3017. The program is loaded into the RAM 3016 for execution. The program may be directly loaded from the CD-ROM 3101 or a network.

The program may not include an operating system (OS) for causing the computer 301 to function as the question processing device 1 according to the above embodiment or a third-party program. The program may include an instruction set to obtain intended results by calling an appropriate function (module) in a controlled manner. The operation of the computer system 300 is known and will not be described in detail.

In the program, transmitting information or receiving information does not include processing performed by hardware, such as processing performed by a modem or an interface card in the transmission (hardware-specific processing).

The programs may be executable by a single computer or by multiple computers. In other words, centralized processing or distributed processing may be performed.

In each of the above embodiments, two or more communicators in one device may be physically implemented by a single medium.

In each of the above embodiments, each process may be implemented on a single device through centralized processing or on multiple devices through distributed processing.

The present invention is not limited to the above embodiments but may be modified variously, and the modifications also fall within the scope of the present invention.

### INDUSTRIAL APPLICABILITY

As described above, the question processing device 1 according to the embodiments of the present invention can perform effective information processing on questions transmitted from students during a lecture and provide appropriate benefit to the students or the instructor, thus being useful as, for example, a server that processes questions in a lecture.

### REFERENCE SIGNS LIST

A question processing system
1 question processing device
2 student terminal
3 instructor terminal
11 storage
12 receiver
13 processor
14 transmitter
21 student storage
22 student accepter
23 student processor
24 student transmitter
25 student receiver
26 student outputter
31 instructor storage
32 instructor accepter
33 instructor processor
34 instructor transmitter
35 instructor receiver
36 instructor outputter
111 student manager
112 question manager
113 material manager
114 recommended-question manager
121 question receiver
122 reaction receiver
131 material obtainer
132 question processor
141 material transmitter
142 result transmitter
1321 correspondence obtainer
1322 question storage
1323 level obtainer
1324 level storage
1325 question recommender
1326 combiner
1327 sorter
1328 combined-question transmitter
1329 question identifier receiver
1330 page transmitter
1331 student evaluator
1332 material analyzer

1. A question processing device, comprising:
a question receiver configured to receive, during a lecture provided by an instructor to two or more students, a question about the lecture from each of two or more student terminals;
a question processor configured to perform information processing on two or more questions received by the question receiver and obtain a processing result; and
a result transmitter configured to transmit the processing result obtained by the question processor to an instructor terminal or the two or more student terminals.

2. The question processing device according to claim 1, wherein
the question receiver receives a question associated with a student identifier,
the question processing device further comprises a reaction receiver configured to receive reaction information indicating an evaluation on each question of the two or more questions, the reaction receiver being configured to receive the reaction information from a student terminal held by at least one student other than a student who has transmitted the each question, and
the question processor includes
a level obtainer configured to obtain, using the reaction information received by the reaction receiver, a level of the question corresponding to the reaction information, and
a level storage configured to store the level obtained by the level obtainer in a manner associated with the student identifier.

3. The question processing device according to claim 2, wherein
the question processor further includes a question recommender configured to obtain, from a question manager managing two or more levels in a manner each associated with at least one question, a question associated with a level of a student identified by the student identifier and transmit the obtained question to a student terminal identified by the student identifier.

4. The question processing device according to claim 1, wherein
the question processor includes
a combiner configured to combine two or more questions satisfying a similarity condition into a single question among two or more questions received by the question receiver during a lecture, and
a combined-question transmitter configured to transmit at least one question remaining after the combiner combining the two or more questions.

5. The question processing device according to claim 4, wherein
the combiner combines, at a predetermined time in the lecture, the two or more questions satisfying the similarity condition into the single question among the two or more questions received by the question receiver during the lecture.

6. The question processing device according to claim 4, wherein
the question processor further includes a sorter configured to sort, in descending order, questions resulting from the combining performed by the combiner using a number of original questions as a key, and
the combined-question transmitter transmits two or more questions resulting from the combining and sorted by the sorter.

7. The question processing device according to claim 1, wherein
the lecture is provided by the instructor with material having two or more pages, and
the question processor includes
a correspondence obtainer configured to detect correspondence between the question received by the question receiver and a page of the material and obtain a page identifier identifying the page, and
a question storage configured to store the question in a manner associated with the page identifier or the page.

8. The question processing device according to claim 7, wherein
the question processor further includes
a question identifier receiver configured to receive a question identifier identifying a question from the instructor terminal, and
a page transmitter configured to transmit a page identifier or a page paired with the question identifier to the instructor terminal.

9. A question processing method implementable with a question receiver, a question processor, and a result transmitter, the method comprising:
receiving, with the question receiver, during a lecture provided by an instructor to two or more students, a question about the lecture from each of two or more student terminals;
performing, with the question processor, information processing on two or more questions received by the question receiver and obtaining a processing result; and
transmitting, with the result transmitter, the processing result obtained by the question processor to an instructor terminal or the two or more student terminals.

10. A non-transitory computer-readable storage medium storing program for causing a computer to function as:
a question receiver configured to receive, during a lecture provided by an instructor to two or more students, a question about the lecture from each of two or more student terminals;
a question processor configured to perform information processing on two or more questions received by the question receiver and obtain a processing result; and
a result transmitter configured to transmit the processing result obtained by the question processor to an instructor terminal or the two or more student terminals.

11. The question processing device according to claim 5, wherein
the question processor further includes a sorter configured to sort, in descending order, questions resulting from the combining performed by the combiner using a number of original questions as a key, and
the combined-question transmitter transmits two or more questions resulting from the combining and sorted by the sorter.
